(19) United States
(12) Patent Application Publication
(10) Pub. No.: US 2015/0314322 A1
(43) Pub. Date: Nov. 5, 2015

(54) METHOD OF APPLYING A PROTECTIVE COATING TO SUBSTRATE EDGES

(71) Applicant: CORNING INCORPORATED, Corning, NY (US)

(72) Inventors: Shih-Min Chang, Taipei City (TW); Cheng-Ta Chen, Taichung City (TW); Chao-Yin Chuang, Taichung City (TW); Hsien Li Lu, Taichung City (TW)

(21) Appl. No.: 14/695,564

(22) Filed: Apr. 24, 2015

Related U.S. Application Data
(60) Provisional application No. 61/986,234, filed on Apr. 30, 2014.

(51) Int. Cl. B05D 1/00; B05D 3/14; B05D 3/00

(52) U.S. Cl. CPC B05D 1/005; B05D 3/007; B05D 3/142

(57) ABSTRACT

A method of applying a protective coating to a substrate includes applying a surface treatment to edges of the substrate to increase surface wettability of the edges and/or preheating the substrate. A curable coating material is applied to the edges. Then, the substrate is spun to adjust a thickness and uniformity of the curable coating material applied on the substrate edges. The curable coating material is cured to form the protective coating on the substrate edges.

This application claims the benefit of priority under 35 U.S.C. §119 of U.S. Provisional Application Ser. No. 61/986234 filed on Apr. 30, 2014 the content of which is relied upon and incorporated herein by reference in its entirety.

### FIELD

The field relates to methods for improving the impact strength of glass or glass-ceramic articles that have been subjected to weakening processes such as separation and machining. More particularly, the field relates to a method for applying a protective coating to edges of a substrate, such as a glass or glass-ceramic article adapted for use in display applications.

### BACKGROUND

Processes such as separation and machining when applied to brittle material such as glass often result in material edges with flaws, e.g., cracks and chips, of various shapes, sizes, and dimensions. These flaws make the brittle material susceptible to damage since the flaws become failure sites at which fracture can be initiated when the brittle material is under high stress or when direct impact is made with the flaws. To improve the resistance of the brittle material to impact damage, a protective coating may be applied to the flawed edges. The protective coating will cover the flaws, thereby preventing direct impact with the flaws.

### SUMMARY

The subject matter disclosed herein relates to a method of applying a protective coating to edges of a substrate, which may be made of a brittle material such as glass or glass-ceramic.

In one illustrative embodiment, a method of applying a protective coating to a substrate includes applying a surface treatment to at least one edge of the substrate to increase a surface wettability of the at least one edge and/or preheating the substrate. After the surface treatment and/or preheating of the substrate, a curable coating material is deposited on the at least one edge. The substrate is then spun at a select spin speed and for a select duration to adjust the uniformity and thickness of the curable coating. After the spinning, the curable coating material is cured to form the protective coating on the at least one edge.

It is to be understood that both the foregoing general description and the following detailed description are exemplary. The above illustrative embodiment and additional illustrative embodiments are further described in the accompanying drawings and the detailed description.

### BRIEF DESCRIPTION OF THE DRAWINGS

The following is a description of the figures in the accompanying drawings. The figures are not necessarily to scale, and certain features and certain views of the figures may be shown exaggerated in scale or in schematic in the interest of clarity and conciseness.

FIG. 1 shows a process flow for edge-coating a substrate according to one illustrative embodiment.

FIG. 2A shows viscosity as a function of temperature for high viscosity and low viscosity coating materials.

FIG. 2B shows contact angles for virgin and surface-treated glass samples.

FIG. 3 shows results from coating a virgin glass sample.

FIG. 4 shows results from coating a surface-treated glass sample.

FIG. 5 shows results from subjecting a glass sample to a spin process after coating.

FIG. 6 shows coating on a glass sample before baking.

FIG. 7 shows results from subjecting a glass sample to baking after coating.

### DETAILED DESCRIPTION

The edges of a substrate resulting from processes such as separation and machining may be subjected to one or more auxiliary processes before and/or after applying a curable coating material on the substrate edges to achieve a high-quality protective coating on the substrate edges. The auxiliary processes may be selected from (i) subjecting the edges of the substrate to a surface treatment prior to applying the curable coating material to the substrate edges, (ii) preheating the substrate (or a stage on which the substrate is mounted) prior to applying the curable coating material to the substrate edges, (iii) subjecting the substrate to a spin process after applying the curable coating material to the substrate edges but before curing the curable coating material, and (iv) baking the curable coating material prior to curing the curable coating material.

In the auxiliary processes described above, the surface treatment that is of interest is one that is capable of improving the surface wettability of the substrate edges. Wetting is the ability of a liquid to maintain contact with a solid surface. The higher the wettability of a solid material, the more easily a liquid can spread over a large area of the solid material. Wettability depends on the surface energy of the solid material and is measured in terms of contact angle of a liquid droplet with the solid material. Wettability increases as surface energy increases and as contact angle decreases. Increasing the surface wettability of the substrate edges prior to applying the curable coating material to the substrate can have the effect of improving adhesion of the curable coating material to the substrate edges.

The effects of the auxiliary processes described above on coating quality are summarized in Table 1. From Table 1, combining coating process C or D with B can improve coverage of the coating, combining process D with B can improve coverage and uniformity of the coating, combining process E with B can eliminate bubbles in the coating, and combining processes B through D can improve coverage and uniformity of the coating and eliminate bubbles in the coating. Other combinations of the auxiliary processes to achieve high-quality coating are possible.

TABLE 1

| | | | Coating | |
|---|---|---|---|---|
| | | Coating | Unifor- | |
| Coating Process | | Coverage | mity | Observation |
| A | Coating □ Curing | Poor | Poor | Wetting was |
| | | | | difficult; no |
| | | | | coverage on |
| | | | | some parts |
| B | Acetone rinsing (surface | Good | Good | Wetting was |
| | treatment) □ Coating □ | | | easy; bubbles |
| | Curing | | | were observed |
| | | | | after jet coating |
| C | Preheating glass or stage □ | Good | Good | Coverage was |
| | Coating □ Curing | | | easy |
| D | Coating □ Spin □ | Good | Good | Coverage and |
| | Curing | | | uniformity |
| | | | | improved |
| E | Coating □ Baking □ | Good | Poor | Bubbles |
| | Curing | | | eliminated |

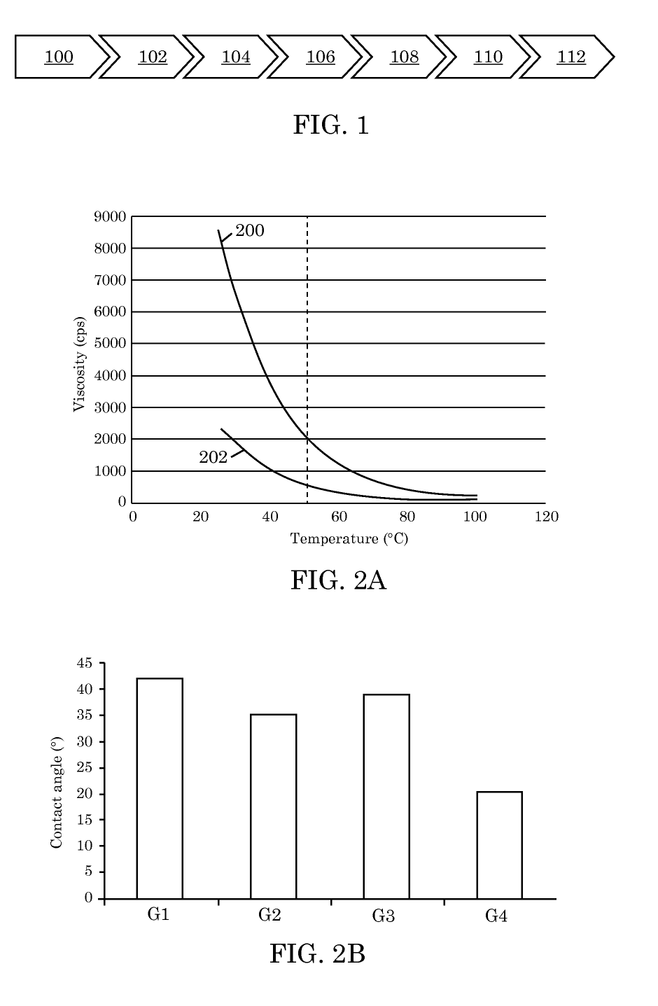

FIG. 1 shows an illustrative process flow for applying a protective coating to the edges of a substrate. The substrate may be made of a single layer of material or multiple layers of different materials. In one illustrative embodiment, the substrate is selected from a glass sheet, a glass-ceramic sheet, an ion-exchanged glass sheet, an ion-exchanged glass-ceramic sheet, and an integrated touch glass sheet (or panel). In one embodiment, the integrated touch glass sheet includes a layer of sensor material on a glass or glass-ceramic sheet, which may be ion-exchanged. The integrated touch glass sheet may be formed through ITO sensor deposition on the (ion-exchanged) glass or glass-ceramic sheet. The edges of the substrate may have flaws due to processes such as separation and machining. The flaws in the edges may have been reduced in size and/or the tips of the flaws in the edges may have been blunted using processes such as etching.

According to the illustrative process of FIG. 1, a surface treatment is applied (100) to at least the substrate edges to increase the surface energy, and therefore the surface wettability, of the substrate edges. In some cases, it may be convenient to apply the surface treatment to the entire substrate. There are various surface treatments that could be used to increase the surface energy, and therefore the surface wettability, of the substrate edges.

In one illustrative embodiment, the surface treatment includes solvent cleaning, where the substrate edges are cleaned by immersing or rinsing them in a solvent, by wiping them with a cloth moistened with a solvent, or by exposing them to vapors of a solvent. The solvent may be selected from hydrocarbons, alcohols, ketones, esters, and other organic solvents, for example.

The Hildebrand solubility parameter (δ) provides a numerical estimate of the degree of interaction between materials and can be a good indication of solubility, particularly for non-polar materials such as many polymers. Materials with similar values of δ are likely to be miscible, which is desirable for promoting surface wettability. When using a solvent to treat the substrate edges, the solubility parameter of the solvent should be as close as possible to the curable coating material that will be applied to the substrate edges. For example, if the curable coating material is a polymer, the solubility parameter of the solvent may be considered to be close to the solubility parameter of the polymer if the difference between the solubility parameter of the polymer (MPa^{1/2}) and the solubility parameter of the solvent (MPa^{1/2}) is less than ±1 MPa^{1/2}. For example, acetone (with solubility parameter of 20.3 MPa^{1/2}) for surface treatment and epoxy (with solubility parameter of 20.4 MPa^{1/2}) for curable coating material will be a good combination. Other examples of suitable combinations of polymers and solvents are shown in Table 2.

TABLE 2

| | Solubility | | Solubility |
|---|---|---|---|
| | of Polymer | | of Solvent |
| Polymer | (MPa^{1/2}) | Solvent | (MPa^{1/2}) |
| Epoxy | 20.4 | Acetone | 20.3 |
| Poly(ethyl | 17.6 | Carbon | 17.6 |
| Methacrylate) | | tetrachloride | |
| Isoprene elastomer | 16.6 | Di-butyl amine | 16.6 |
| Poly(vinyl chloride) | 18.2 | Xylene | 18.0 |
| Cellulose acetate | 18.6 | Benzene | 18.8 |
| Poly(methyl | 18.6 | Benzene | 18.8 |
| methacrylate) | | | |

In another illustrative embodiment, the surface treatment includes plasma cleaning. In plasma cleaning, impurities and contaminants are removed from substrate edges through the use of an energetic plasma or dielectric barrier discharge (DBD) plasma created from gaseous species. Gases such as argon and oxygen, as well as mixtures such as air and hydrogen/nitrogen, are used. If contaminants have carbon and oxygen elements, the excited ions generated by the plasma will react with the carbon and oxygen to form CO₂, H₂O, and CH₄. These gases can be discharged, e.g., via a vacuum system. There are various types of plasma treatment technologies that could be used for the plasma cleaning, e.g., corona treatment, atmospheric plasma treatment, flame plasma treatment, and chemical plasma treatment. In some embodiments, plasma cleaning may be preceded by solvent cleaning.

In another illustrative embodiment, the surface treatment includes grafting a coupling agent, e.g., a silane coupling agent, to the substrate edges. Silane coupling agents are silicon-based chemicals that contain two types of reactivity—inorganic and organic—in the same molecule. A typical general structure is (RO)₃SiCH₂CH₂CH₂-X, where RO is a hydrolyzable group, such as methoxy, ethoxy, or acetoxy, and X is an organofunctional group, such as amino, methacryloxy, epoxy, etc. Silane is an interface between inorganic (glass, metal, and mineral) and organic materials. When epoxy is used as the curable coating material, for example, a silane coupling agent with organic reactivity selected from, for example, amino, epoxy, mercapto, isocynate, benzylamino, chloropropyl, melaime, and vinyl-benzyl-amino can be used for the surface treatment. The silane coupling agent may be different for other types of curable coating materials. The coupling agent, which may be present, for example, in an amount from 0.01 to 5 wt % in a solution, may be grafted to the substrate edges by immersing the substrate edges in the solution or by wiping the substrate edges with a cloth moistened with the solution.

After the surface treatment is applied to at least the substrate edges, the substrate is preheated (102). The substrate may be heated directly. Alternatively, a stage on which the substrate is mounted may be heated, where at least a portion of the heat applied to the stage will generally be transferred to the substrate such that the substrate is effectively being heated. The stage may be a spinning stage that will be rotated during a spin process. The stage may also provide support to the substrate while applying the curable coating material to the substrate edges. The temperature to which the substrate is preheated is selected to facilitate removal of bubbles from the coating material and to prevent flow of the coating material from the substrate edges to the (non-edge) surfaces of the substrate. The substrate (or stage on which the substrate is mounted) may be preheated such that when the coating material is in contact with the substrate edges, during coating of the substrate edges, the viscosity of the coating material will be below 1,000 cps, for removal of bubbles from the coating material, but above 50 cps, for avoidance of flow of the coating material onto the surfaces of the substrate. Typically, the highest preheating temperature will be below 200° C. for both high viscosity and low viscosity coating materials. For high viscosity coating material, i.e., coating material having viscosity at or above 4,000 cps at room temperature of 25° C., the preheating temperature is typically above 60° C. For low viscosity coating material, i.e., coating material having viscosity below 4,000 cps at room temperature of 25° C., the preheating temperature is typically above 40° C. In general, the preheating temperature may be between 40° C. and 200° C.

After preheating the substrate (or the stage on which the substrate is mounted), a curable coating material is applied (104) to the substrate edges. In one illustrative embodiment, the curable coating material is provided in liquid form. In one illustrative embodiment, the curable coating material is a polymer resin, which has high transparency and good wettability on a glass or glass-ceramic surface and is available in liquid form. In one illustrative embodiment, the curable coating material is selected from acrylic, epoxy, silicone, transparent polyimide, and hard coating material. The curable coating material may be selected based on the type of surface treatment applied to the substrate edges. Any suitable method may be used to apply the curable coating material to the substrate edges. One example of a suitable method is by jet coating, where the curable coating material is supplied into a dispenser in liquid form and then jetted onto the substrate edges via the nozzle of the dispenser. Jet coating is described in, for example, U.S. patent application Ser. No. 14/185,101. The jetted material will form beads on the substrate edges, which will spread to cover the substrate edges. The coating material may be applied by other methods besides jetting, e.g., by dipping, spraying, or painting with a brush or roller.

After applying the curable coating material to the substrate edges, the substrate may be subjected to a spin process (106). In one illustrative embodiment, this involves rotating a stage on which the substrate is mounted at a select spin speed and for a select spin time. During the spinning of the substrate, coverage and uniformity of the curable coating material on the substrate edges will be improved and excess coating material will be removed from the substrate edges by centrifugal force. The spin speed and time can be controlled to achieve a desired thickness and quality of the curable coating. In general, the higher the spinning speed, the thinner the coating thickness will be. Also, the longer the duration of the spinning, the thinner and smoother the coating thickness will be. Typically, thin coatings, e.g., less than 100 μm, are preferred for electronic display applications. In general, spin speed may be from 200 rpm to 2,500 rpm and spin duration may be from 15 s to 70 s. In one illustrative embodiment, spin parameters are selected from 1,500 rpm for 60 s, 200 rpm for 60 s, 500 for 30 s followed by 1,500 rpm for 30 s, and 500 rpm for 30 s followed by 2,000 rpm for 30 s. However, these spin parameters are just examples and can be readily tailored to achieve desired results.

After the spinning process, the curable coating material applied to the substrate edges is baked (108) in an oven. The baking is typically applied before the curable coating material becomes solid. This baking helps eliminate bubbles in the curable coating material. In one illustrative embodiment, the baking temperature is selected such that the viscosity of the curable coating material is below 2,000 cps for elimination of the bubbles. FIG. 2A shows typical viscosity as a function of temperature for high viscosity (200) and low viscosity (202) coating materials. At temperatures over 50° C., a high viscosity coating material will typically have a viscosity below 2,000 cps. Based on FIG. 2A, a baking temperature in a range from 50° C. to 150° C. may be used to eliminate bubbles from, or significantly reduce bubbles in, the coating material. The duration of the baking may be from 1 minute to 10 minutes but will generally be determined based on the particular coating material and conditions.

After baking, the curable coating material is cured to form the protective coating on the substrate edges. The curing may be carried out in two stages (110, 112). The second curing (112), which may also be described as post curing, may be at a higher temperature than used for the first curing (110) or may be at the same temperature as used for the first curing but for a longer duration. The curing temperature(s) and time(s) will depend on the type of curable coating material. UV light may be used for the curing if the curable coating material is a UV curable coating material. Otherwise, the appropriate method of curing the curable coating material should be selected.

Although the process in FIG. 1 has been described as including surface treatment (100), preheating (102), spinning (106), and baking (108), it should be noted that one or more of these auxiliary processes may be omitted from the coating process in alternate embodiments. In particular, the auxiliary processes included in the coating process may be selected depending on the nature of the coating material and method of applying the coating. One example of a suitable combination different from the one shown in FIG. 1 is surface treatment (100), followed by coating (104), followed by spinning (106), followed by curing (110, 112). Another example is surface treatment (100), followed by coating (104), followed by spinning (106), followed by curing (110, 112). Another example is preheating (102), followed by coating (104), followed by spinning (106), followed by curing 110, 112). Another example is preheating (102), followed by coating (104), followed by spinning (106), followed by baking (108), followed by curing (110, 112).

Spinning (106) is useful in thinning out the coating thickness as well as improving the uniformity of the coating. This is particularly relevant when very high viscosity coating material (e.g., having viscosity on the order of 8,500 cps at room temperature) is used. Because the coating material is liquid, the coating material will sag after it is deposited on the substrate edges. The spin process can help avoid sagging of the coating material onto the surfaces of the substrate. At the same time, the sagging can assist in achieving even coverage of the coating material on the substrate edges. Preheating of the substrate or stage (102) is useful in avoiding formation of bubbles when the coating material is applied. If after the coating material is applied there are bubbles in the coating material, the baking (108) will help reduce both the number and sizes of the bubbles in the coating material. The surface treatment (100) will improve wettability of the substrate edges.

### Example 1

FIG. 2B shows contact angles of glass samples G1, G2, G3, G4. Glass G1 and G3 are virgin (non-surface-treated) GORILLA 2318 glass samples. The contact angle of glass G1 with high viscosity resin as testing droplet is 42.0°, and the contact angle of glass G3 with low viscosity resin as testing droplet is 38.8°. Glass G2 and G4 are GORILLA 2318 glass samples subjected to vacuum plasma cleaning. The contact angle of glass G2 with high viscosity resin as testing droplet is 35°, and the contact angle of G4 with low viscosity resin as testing droplet is 20.4°. The results show that surface wettability of glass improved after vacuum plasma cleaning. Vacuum plasma cleaning is vacuum cleaning with removal of dissipated gases using vacuum.

### Example 2

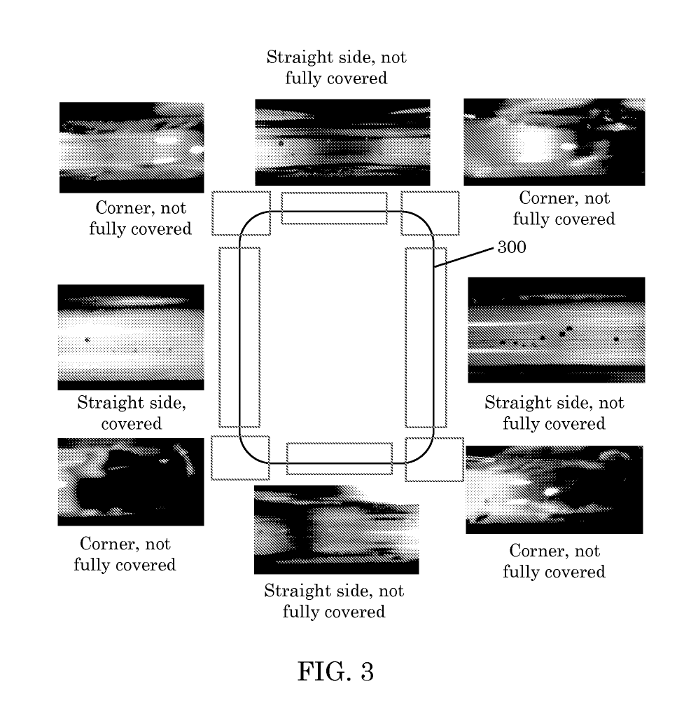

The edges of a virgin GORILLA 2318 glass sample were coated with epoxy resin by jetting. The results, in FIG. 3, show no full coverage in many positions along the edges of the glass sample (300). The width of no full coverage was from 0.5 to 2.5 mm for the corners and 0.5 mm for the straight sides.

### Example 3

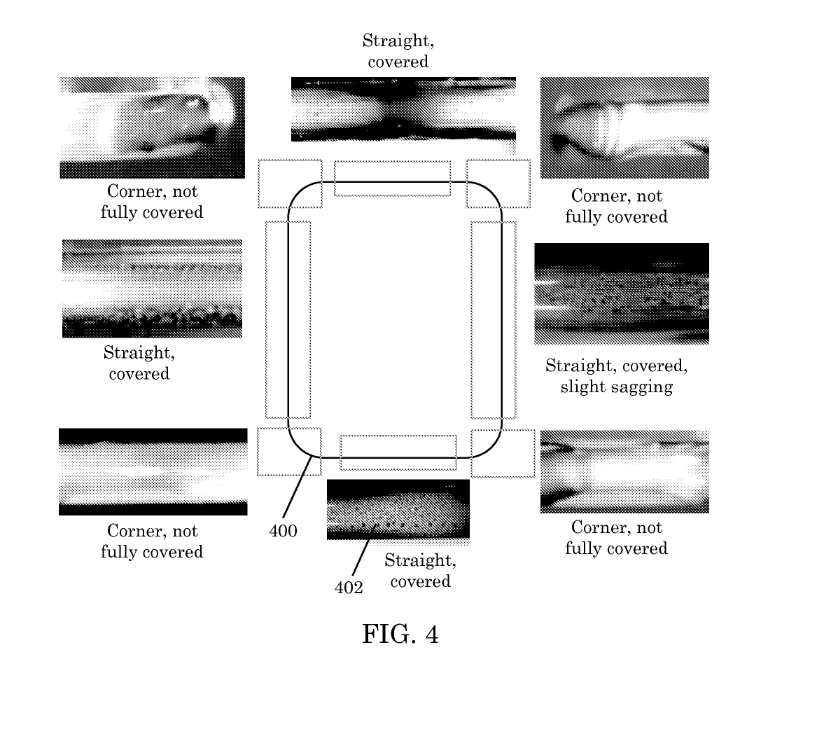

A GORILLA 2318 glass sample was rinsed in acetone prior to applying epoxy resin on the edges of the glass sample by jetting. Acetone and epoxy have similar solubility parameters. The solubility parameter of acetone is 20.3 MPa^{1/2}, and the solubility parameter of epoxy is 20.4 MPa^{1/2}. The results, in FIG. 4, show that most of the straight parts of the edges of the glass sample (400) were fully covered, which shows that acetone treatment improves glass wetting. However, full coverage at the glass corners was difficult. The width of no full coverage was 2.0 to 2.5 mm for the corners. Some sagging of the coating was observed on the straight parts of the edges.

### Example 4

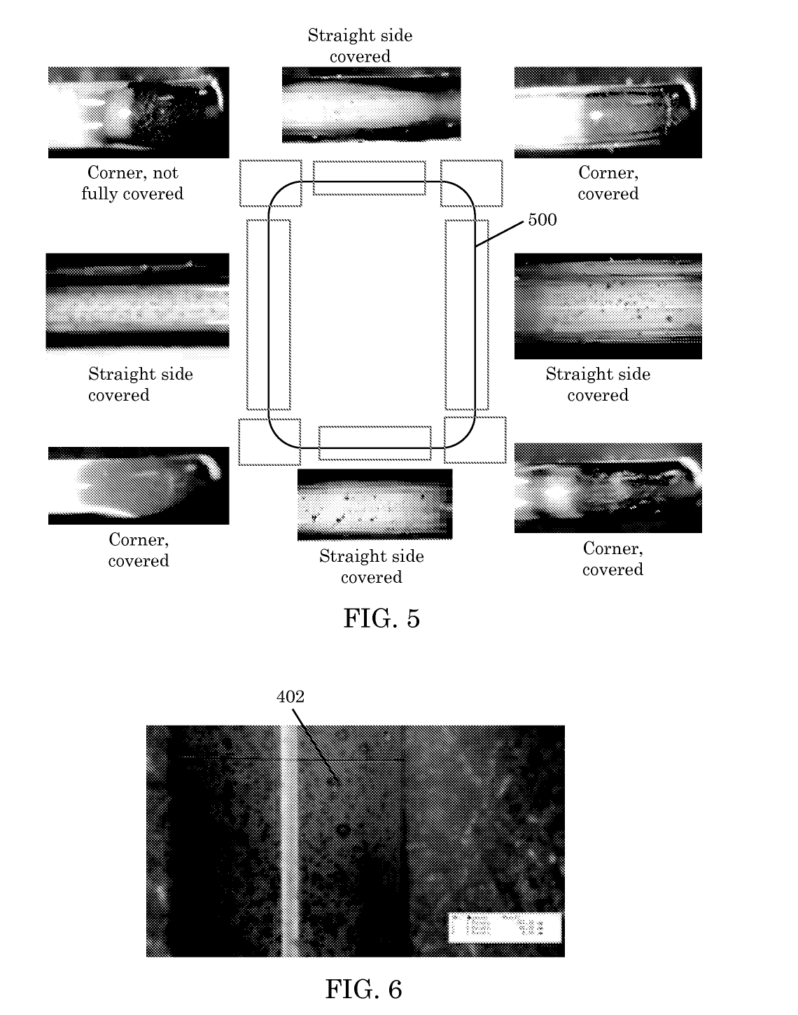

The glass sample of Example 3 was subjected to a spin process after the jet coating process. The spin process included a first spin at 500 rpm for 30 s followed by a second spin at 1700 rpm for 30 s. The results, in FIG. 5, show that the coverage width of the sample (500) improved by about 0.5 to 1.0 mm for the corners compared to Example 3. The coverage width may be further improved by adjusting the spin parameters.

### Example 5

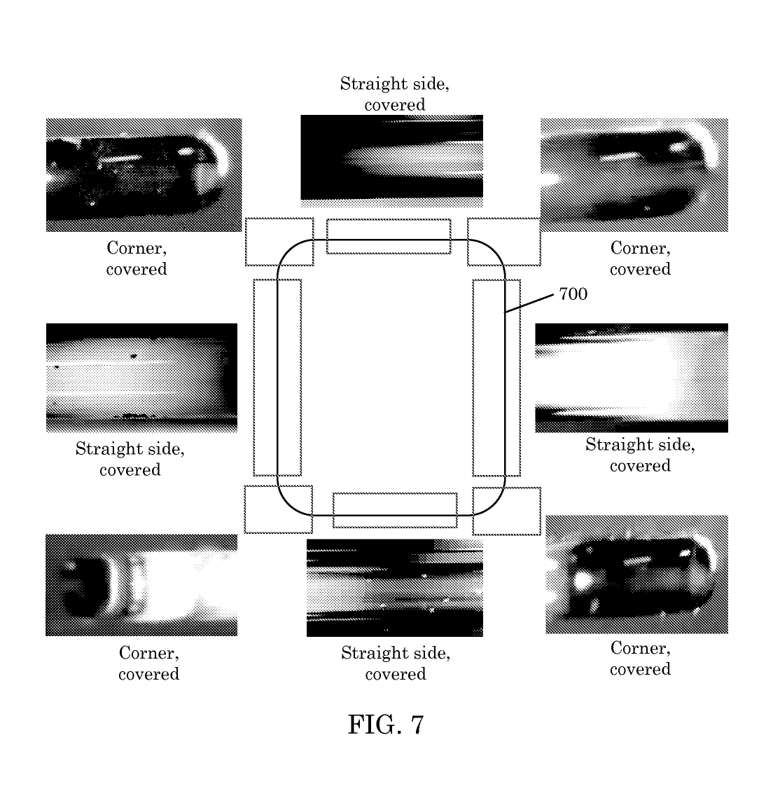

The glass sample of Example 3 was subjected to baking at 125° C. for 5 min after the jet coating process. After the jet coating process, and before baking, there were bubbles in the applied epoxy. FIG. 6 shows an enlargement of a coating with bubbles 402 before baking. After the baking process, most of the bubbles had disappeared and the remaining bubbles had a size of around 50 μm. FIG. 7 shows the results of the coating with baking. Note that the bubbles 402 visible in FIG. 4 (FIG. 6) are no longer visible in FIG. 7.

### Example 6

A virgin Gorilla 2318 glass sample having a thickness of 0.7 mm was found to resist up to 0.39 J in a ball drop test. A virgin Gorilla 2318 glass sample was manually coated with epoxy. The epoxy-coated Gorilla 2318 glass sample was found to resist up to 0.49 J in a ball drop test. Another virgin Gorilla 2318 glass sample was manually coated with epoxy, followed by spinning the glass. The spun epoxy-coated Gorilla 2318 glass was found to resist up to 0.98 J in a ball drop test. The ball drop test involved setting the glass vertically and dropping a 500 g ball on the glass from different distances. Each glass sample had a size of 60 mm by 44 mm by 0.7 mm. The coating thickness was 0.43 mm. For curing, UV dosage of greater than 30 J/cm² was used. The spin speed was 1500 rpm for 20 s. The epoxy was post cured at 150° C. for 2 hours. This example shows that spinning after coating improved impact strength of the glass.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

1. A method of applying a protective coating to a substrate, comprising:
at least one of (i) applying a surface treatment to at least one edge of the substrate to increase a surface wettability of the at least one edge and (ii) preheating the substrate;
applying a curable coating material to the at least one edge after the at least one of applying the surface treatment and preheating the substrate;
spinning the substrate to adjust a thickness and uniformity of the curable coating material applied on the at least one edge; and
curing the curable coating material to form the protective coating on the at least one edge.

2. The method of claim 1, wherein the preheating the substrate is preceded by the applying the surface treatment to the at least one edge.

3. The method of claim 1, wherein the surface treatment is applied to the at least one edge, and wherein the surface treatment comprises at least one process selected from the group consisting of cleaning the at least one edge by a solvent, cleaning the at least one edge by plasma, and grafting a silane coupling agent to the at least one edge.

4. The method of claim 3, wherein the substrate comprises a glass or glass-ceramic, the curable coating material comprises a polymeric resin, and the surface treatment comprises cleaning the surface of the at least one edge with an organic solvent.

5. The method of claim 3, wherein the surface treatment comprises cleaning the surface by plasma while removing dissipated gases from the cleaning with vacuum.

6. The method of claim 1, wherein the sheet material is preheated such that a viscosity of the curable coating material on the at least one edge during the applying the curable coating material is below 1,000 cps.

7. The method of claim 6, wherein the substrate is preheated to a temperature between 40° C. and 200° C.

8. The method of claim 1, further comprising baking the curable coating material at a baking temperature selected to lower a viscosity of the curable coating material to below 2,000 cps prior to curing the curable coating material.

9. The method of claim 8, wherein the baking temperature is in a range from 50° C. to 150° C.

10. The method of claim 1, wherein the curing is performed in two stages, wherein at least one curing parameter of the first stage of curing is different from a corresponding parameter of the second stage of curing.
